(19) United States
(12) Patent Application Publication
(10) Pub. No.: US 2011/0091770 A1
(43) Pub. Date: Apr. 21, 2011

(54) RECHARGEABLE BATTERY, BIPOLAR ELECTRODE, AND METHOD OF MANUFACTURING RECHARGEABLE BATTERY

(75) Inventors: Man-Seok HAN, Yongin-si (KR); Eui-Hwan SONG, Yongin-si (KR); Sumihito ISHIDA, Yongin-si (KR); Satoshi NARUKAWA, Yongin-si (KR); Jin-Kyu HONG, Yongin-si (KR); Jun-Sik KIM, Yongin-si (KR); Kyeu-Yoon SHEEM, Yongin-si (KR); Tae-Keun KIM, Yongin-si (KR); Mee-Young LEE, Yongin-si (KR)

(73) Assignee: SAMSUNG SDI CO., LTD., Yongin-si (KR)

(21) Appl. No.: 12/904,037

(22) Filed: Oct. 13, 2010

(30) Foreign Application Priority Data
Oct. 16, 2009 (KR) 10-2009-0098888

(51) Int. Cl. H01M 10/18; H01M 10/24; H01M 4/26

(52) U.S. Cl. 429/210; 29/623.2; 29/623.5

(57) ABSTRACT

A rechargeable battery that can have high energy density and high power density. The rechargeable battery includes: bipolar electrodes including a current collector, a sealing layer that is formed at the edge of the current collector, a first electrode active material layer that is inserted into a space in that is formed within the sealing layer, and a second electrode active material layer that is formed at the opposite side of the first electrode active material layer; and a separator that is disposed between the bipolar electrodes, wherein the sealing layer is bonded with the sealing layer of neighboring bipolar electrodes.

### CROSS-REFERENCE TO RELATED APPLICATIONS

This application claims the benefit of Korean Application No. 10-2009-0098888, filed in the Korean Intellectual Property Office on Oct. 16, 2009, the disclosure of which is incorporated herein by reference.

### BACKGROUND

1. Field

The described technology relates generally to a rechargeable battery, a bipolar electrode, and a method of manufacturing a rechargeable battery. More particularly, the described technology relates generally to a rechargeable battery in which a sealing layer is formed along the edge of a current collector, as well as a bipolar electrode and a method of manufacturing a rechargeable battery.

2. Description of the Related Technology

A rechargeable battery can be repeatedly re-charged and discharged, unlike a primary battery that cannot be re-charged. A low capacity rechargeable battery is used for a small portable electronic device, such as a mobile phone, a laptop computer, and a camcorder, and a large capacity rechargeable battery is widely used as a power source for driving a motor, such as a hybrid vehicle.

Currently, a high power rechargeable battery using a high energy density non-aqueous electrolyte has been developed, and such a high power rechargeable battery is formed with a large capacity by coupling a plurality of rechargeable batteries in series in order to drive the motor of an appliance, for example, an electric vehicle that necessitates a large amount of electric power. Further, the rechargeable battery can be formed in a cylindrical shape or a square shape. Such rechargeable batteries are classified generally into monopolar electrode batteries in which an active material having the same polarity is coated at both surfaces of the current collector, and bipolar electrode batteries in which active materials having different polarities are coated on opposite surfaces of the current collector.

A rechargeable battery using a monopolar electrode should have a connection portion for connecting electrodes. However in such a structure, the output drops due to electrical resistance of the connection portion. The bipolar electrode is an electrode that can be used by stacking electrodes without such a connection portion, and can minimize connection resistance.

In a bipolar battery using a bipolar electrode, it is very important to seal the space between stacked bipolar electrodes. Particularly, it is necessary to prevent leakage of electrolyte solution and to reduce the thickness of the bipolar battery. In general, a gasket is used for sealing, but it is difficult to manufacture the gasket in a thickness smaller than 1 mm. If the thickness of the gasket is too large, the empty space increases between the bipolar electrodes and thus the ratio of output to volume drops. Further, after sealing, the separator is formed with a non-woven fabric or a porous material, and thus electrolyte solution leaks through the separator.

The above information disclosed in this Background section is only for enhancement of understanding of the background of the described technology and therefore it may contain information that does not form the prior art that is already known in this country to a person of ordinary skill in the art.

### SUMMARY OF CERTAIN INVENTIVE ASPECTS

The described technology has been made in an effort to provide a bipolar battery having advantages of an improved output to volume ratio while stably preventing leakage of an electrolyte solution.

An exemplary embodiment of the present invention provides a rechargeable battery including: at least one bipolar electrode containing a current collector, a sealing layer that is formed along one or both surfaces of and at the edge of the current collector, a first electrode active material layer that is inserted into a space within the sealing layer where the current collector is exposed, and a second electrode active material layer that is formed along the opposite surface of the current collector; and a separator that is disposed between the bipolar electrodes, wherein the sealing layer is bonded with the sealing layers of neighboring bipolar electrodes.

The sealing layer may be formed along one surface of the current collector, and the sealing layer may be formed along both surfaces of the current collector. The second electrode active material layer may be inserted into the space that is formed at the inside of the sealing layer, the sealing layer may have a smaller thickness than that of the first electrode active material layer or the second electrode active material layer, and the separator may be positioned within the space that is formed as the sealing layers are bonded.

The separator may be inserted into the space, and the sealing layer may be installed to protrude to the outside of the current collector. A space may be formed in the current collector, the sealing layer may be inserted into the space, and an electrolyte injection opening may be formed in the bipolar electrode.

The current collector and the sealing layer may be formed as a laminate film, and the space may be formed by removing a portion of the sealing layer that is attached to the current collector.

The current collector may be formed using aluminum or stainless steel, and the current collector may be formed using a clad metal in which aluminum and copper are bonded.

Another embodiment of the present invention provides a bipolar electrode for a rechargeable battery, including: a current collector; a sealing layer that is formed along the edge of the current collector; a first electrode active material layer that is inserted into a space that is formed within the sealing layer; and a second electrode active material layer that is formed at the opposite surface of the first electrode active material layer.

The current collector and the sealing layer may be formed with a laminate film, and an electrolyte injection opening in which the sealing layer is not formed may be formed along an edge of the current collector.

Yet another embodiment of the present invention provides a method of manufacturing a rechargeable battery, the method including: preparing a laminate film in which a sealing layer is bonded to both surfaces of a metal plate; forming a space by removing a central portion of the sealing layer; forming a bipolar electrode by disposing a positive active material layer and a negative active material layer in the space; stacking bipolar electrodes by disposing a separator between the bipolar electrodes; and bonding and sealing neighboring sealing layers.

In the stacking of bipolar electrodes, an end portion of the separator may be disposed further inside than the sealing layer, when the sealing layers are bonded, the separator may be positioned within a space that is formed with the bonded sealing layer, and the separator may be inserted into the space to be disposed between the bipolar electrodes.

According to an exemplary embodiment of the present invention, a sealing layer is formed on the surface of the current collector, thereby stably sealing, and because the sealing layer and the current collector can be formed with a laminate film, the output to thickness ratio thereof can be improved.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view illustrating a bipolar electrode according to an exemplary embodiment of the present invention;

FIG. 2 is a vertical cross-sectional view illustrating the joined state of members that are shown in the exemplary embodiment of FIG. 1;

FIG. 3 is a perspective view illustrating a rechargeable battery using the bipolar electrode according to the exemplary embodiment of FIGS. 1 and 2;

FIG. 4 is a cross-sectional view illustrating the rechargeable battery taken along line IV-IV of FIG. 3;

FIG. 5 is a graph illustrating a current and a voltage according to capacity by weight of a pouch type rechargeable battery according to the exemplary embodiment of FIGS. 3 and 4;

FIG. 6 is a graph illustrating capacity and current by weight according to a charge and discharge cycle of a pouch type rechargeable battery according to the exemplary embodiment of FIGS. 3 and 4;

FIG. 7 is a partially cross-sectional view illustrating a rechargeable battery according to another exemplary embodiment of the present invention;

FIG. 8 is a top plan view illustrating a bipolar electrode that is applied to a rechargeable battery according to yet another exemplary embodiment of the present invention;

FIG. 9 is a cross-sectional view illustrating a bipolar electrode taken along line V-V of FIG. 8; and

FIG. 10 is a perspective view illustrating a rechargeable battery according to still another exemplary embodiment of the present invention.

### DETAILED DESCRIPTION OF CERTAIN INVENTIVE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

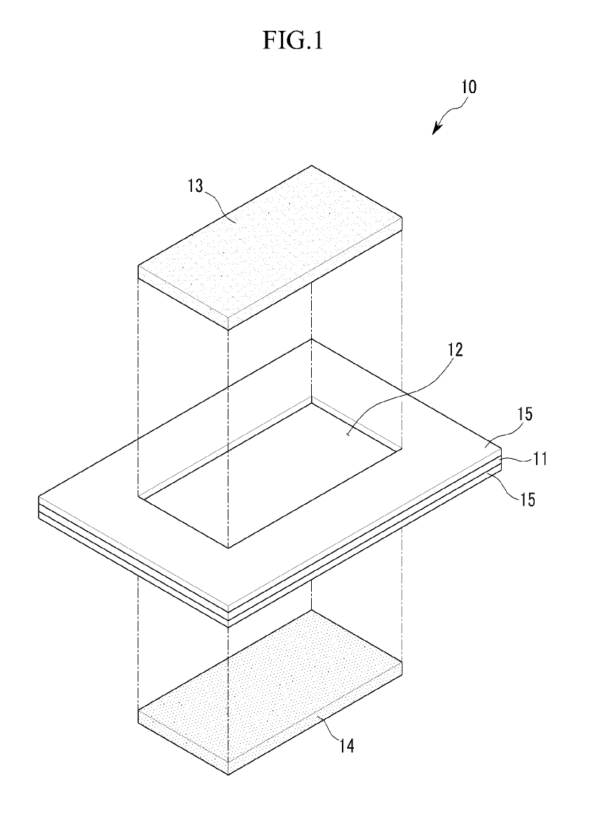

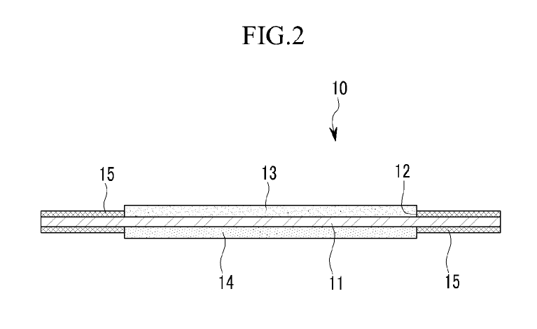

FIG. 1 is an exploded perspective view illustrating a bipolar electrode according to an exemplary embodiment of the present invention, and FIG. 2 is a vertical cross-sectional view illustrating the joined state of the members that are shown in FIG. 1. Referring to FIGS. 1 and 2, a bipolar electrode 10 includes a current collector 11, a sealing layer 15 that is formed along at least one surface of the current collector 11 at the edge of the current collector 11, a positive active material layer 13 that is formed along one surface of the current collector 11, and a negative active material layer 14 that is formed along the other surface of the current collector 11.

The current collector 11 is formed in an approximately quadrangular plate shape, and the sealing layer 15 is formed along the surface or surfaces and at the edge of the current collector 11. Accordingly, the sealing layer 15 is formed in an approximately quadrangular ring shape, a quadrangular space 12 is formed at the central part of both surfaces of the current collector 11, and the positive active material layer 13 and negative active material layer 14 are inserted into the space 12.

The current collector 11 may be aluminum, and the sealing layer 15 may be a polymer such as polypropylene. The current collector 11 and the sealing layer 15 are formed as a laminate film, after forming a polypropylene layer on both surfaces of an aluminum plate, by removing a central portion thereof and exposing the aluminum plate. When the current collector 11 and the sealing layer 15 are formed with a laminate film, the sealing layer 15 can be thinly formed at up to 100 μm. Further, when the current collector 11 and the sealing layer 15 are formed with a laminate film, by cutting the sealing layer 15 without the necessity of coating the sealing layer 15 to correspond to a specific position, the space 12 can be simply formed and thus the production process is simplified and productivity is improved. Further, the current collector 11 can be stainless steel or clad metal in which aluminum and copper are bonded, instead of aluminum.

The positive active material layer 13 is made of a material including a lithium transition metal complex oxide, and the negative active material layer 14 is made of a material including a lithium transition metal complex oxide and a form of carbon such as graphite (also known as black lead). The positive active material layer 13 and the negative active material layer 14 are coated on the current collector 11 or are attached by welding.

The sealing layer 15 can be formed in a smaller thickness than that of the positive active material layer 13 and the negative active material layer 14, as in the present exemplary embodiment, and the sealing layer 15 may be formed with the same thickness or a larger thickness than that of the positive active material layer 13 and the negative active material layer 14.

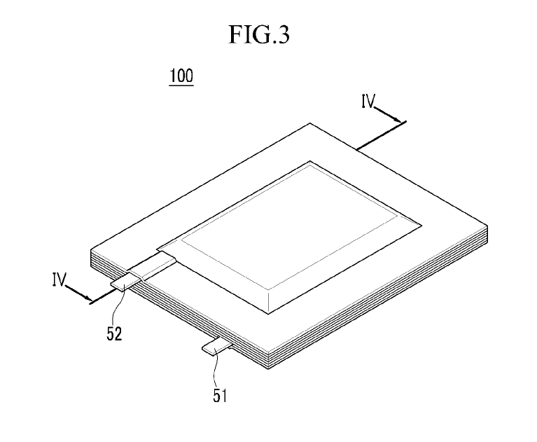

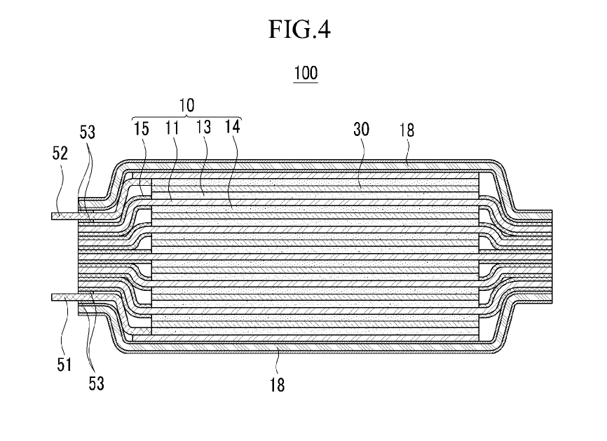

FIG. 3 is a perspective view illustrating a rechargeable battery using the bipolar electrode according to the exemplary embodiment of FIGS. 1 and 2, and FIG. 4 is a cross-sectional view illustrating a rechargeable battery taken along line IV-IV of FIG. 3. Referring to FIGS. 3 and 4, a rechargeable battery 100 according to the present exemplary embodiment includes bipolar electrodes 10, a separator 30 that is interposed between the bipolar electrodes 10, and lead terminals 51 and 52 that are electrically connected to the bipolar electrode 10 to protrude to the outside.

The positive active material layer 13 is disposed to contact one surface of the separator 30, and the negative active material layer 14 is disposed to contact the other surface of the separator 30. The end portion of the separator 30 is positioned further inside than the end portion of the sealing layer 15.

A current can move to the current collector 11 that is positioned at the outermost side via stacked bipolar electrodes 10, and the current is collected by the current collector 11 and is transferred to the outside through the lead terminals 51 and 52. In this embodiment, a positive or negative active material layer is formed along only one surface of the current collector 11 that is positioned at the outermost side.

The lead terminals 51 and 52 are a positive lead terminal 51 and a negative lead terminal 52, and the positive lead terminal 51 is attached by welding to the current collector 11 that is disposed at an uppermost portion while the negative lead terminal 52 is attached by welding to the current collector 11 that is disposed at a lowermost portion. Further, at the side end of the current collector 11 that is positioned at the outermost side, an uncoated portion of the current collector 11 where the sealing layer 15 does not extend is formed, and at the uncoated portion, the current collector 11 and the lead terminals 51 and 52 are bonded by welding.

At the outside of the bipolar electrodes 10, a pouch case 18 formed of a film that encloses the bipolar electrodes 10 is installed, and the pouch case 18 is a laminate film in which a sealing layer 15 is formed along both surfaces of a metal layer. In the present exemplary embodiment, the case 18 is formed in a pouch form, but the present invention is not limited thereto, and the case 18 may be formed with a metal of a square shape or a cylindrical shape.

The current collector 11 and the sealing layer 15, together with the case 18, protrude to the outside beyond the active material layers 13 and 14 and the separator 30, and by fusing and bonding the sealing layers 15 and the case 18 that protrude to the outside together, the entire rechargeable battery 100 can be sealed. An adhesion polymer layer 53 is formed at the circumference of the lead terminals 51 and 52, and as the adhesion polymer layer 53 is bonded with the sealing layer 15, the circumference of the lead terminals 51 and 52 is sealed.

When using the bipolar electrode 10 in which the active material layers 13 and 14 are formed in the space 12 in which the sealing layer 15 is removed in the current collector 11 or a laminate film form in which the sealing layer 15 that is formed with a metal and a polymer is bonded, as in the present exemplary embodiment, the sealing layer 15 of the neighboring current collector 11 is fused and simply sealed. Further, by forming the sealing layer 15 to be thin, the volume of the rechargeable battery 100 is minimized and thus the output to volume ratio thereof can be improved.

The thickness of the sealing layer 15 is formed to be smaller than those of the positive active material 13 and the negative active material 14, and the positive active material 13 and the negative active material 14 are partially inserted into the sealing layer 15. The separator 30 is positioned within a space that is formed as the sealing layers 15 are bonded, and thus an electrolyte solution can be prevented from leaking through the separator 30 that is formed with a non-woven fabric or a porous material.

When the sealing layer 15 is formed along both surfaces of the separator 30, the electrolyte solution moves in a lateral direction along a separator having porosity and thus the electrolyte solution may leak through the separator 30, but as in the present exemplary embodiment, when the separator 30 is positioned within a space in which the sealing layer 15 is sealed, the sealing layer 15 is positioned along the outside of the circumference of the separator 30 and thus the electrolyte solution can be stably prevented from leaking by only bonding the sealing layer 15.

A method of manufacturing a rechargeable battery according to the present exemplary embodiment includes: preparing a laminate film in which a sealing layer is bonded to both surfaces of a metal plate; forming a space 12 by removing a central portion of the sealing layer 15; forming a bipolar electrode 10 by disposing a positive active material layer 13 and a negative active material layer 14 in the space 12; stacking bipolar electrodes 10 by disposing a separator 30 between neighboring bipolar electrodes 10; and bonding and sealing neighboring sealing layers 15.

In the operation of stacking the bipolar electrode 10, by disposing an end portion of the separator 30 between the bipolar electrodes 10 to be positioned further inside than the sealing layers 15, when bonding the sealing layers 15, the entire separator 30 is positioned within a space that is formed with the bonded sealing layer 15. Here, a separator 30 in which an electrolyte solution is impregnated can be used, and in a process of bonding the sealing layer 15, a portion that is partially not bonded exists and the electrolyte solution is injected through the portion and the remaining portion may be bonded and sealed.

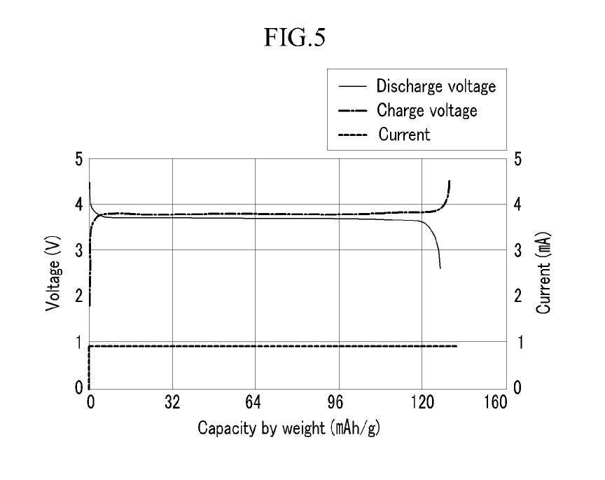

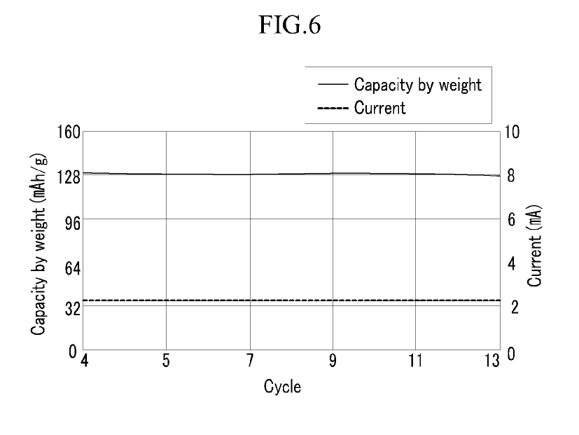

FIG. 5 is a graph illustrating current and voltage according to capacity by weight of a pouch type rechargeable battery having a bipolar electrode, and FIG. 6 is a graph illustrating capacity and current by weight according to a charge and discharge cycle of a pouch type rechargeable battery having a bipolar electrode, both according to the exemplary embodiment of FIGS. 3 and 4. For the bipolar electrode of FIGS. 5 and 6, a sealing layer was formed at the edge thereof, as in this exemplary embodiment, and an active material layer was formed at both holes in which the sealing layer was/not formed. The rechargeable battery of FIG. 5 is a rechargeable battery having a 0.2 C (C-rate) charge and discharge rate, with stable current and voltage characteristics, and initial charge and discharge efficiency of more than 95% at the first stage and more than 98% at the second stage. The rechargeable battery of FIG. 6 is a rechargeable battery having a 0.5 C charge and discharge rate, and retained stable capacity and current characteristics even when the charge and discharge cycle elapsed.

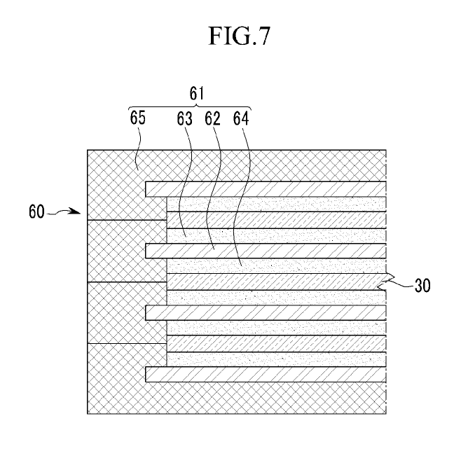

FIG. 7 is a partially cross-sectional view illustrating a rechargeable battery 60 according to another exemplary embodiment of the present invention. Referring to FIG. 7, a bipolar electrode 61 according to the present exemplary embodiment includes a current collector 62, a positive active material layer 63 that is formed along one surface of the current collector 62, a negative active material layer 64 that is formed along the other surface of the current collector 62, and a sealing layer 65 that is formed along the edge of the current collector 62. The sealing layer 65 is coated along the edge of the current collector 62 and protrudes to the outside of the current collector 62 to enclose an end portion of the current collector 62. The positive active material layer 63 and the negative active material layer 64 are disposed at the inside of the sealing layer 65, and the sealing layer 65 is formed with a larger thickness than that of the positive active material layer 63 or the negative active material layer 64 so that the separator 30 may be inserted into an internal space thereof. In the present exemplary embodiment, the current collector 62 and the sealing layer 65 are formed with a laminate film.

The separator 30 is interposed between the bipolar electrodes 61, and a positive active material layer 63 or negative active material layer 64 is formed along only one surface of the current collectors 62 that are positioned at the upper end and lower end, respectively, of the rechargeable battery 60. As in the present exemplary embodiment, the separator 30 is inserted into an internal space of the sealing layer 65, and the sealing layer 65 protrudes to the outside of the current collector 62, thereby sealing the current collector 62 more stably.

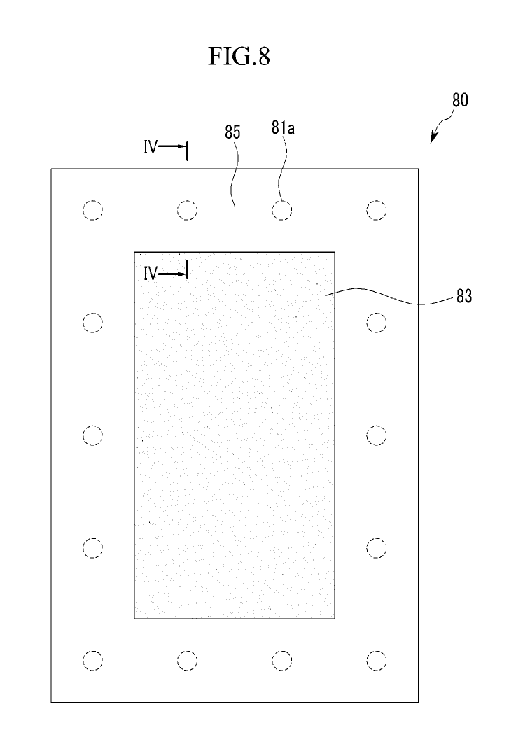

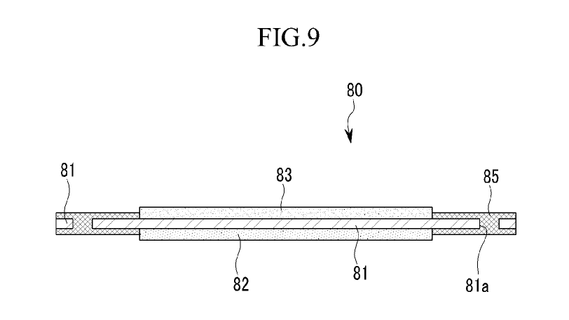

FIG. 8 is a top plan view illustrating a bipolar electrode 80 that is applied to a rechargeable battery according to yet another exemplary embodiment of the present invention, and FIG. 9 is a cross-sectional view illustrating a bipolar electrode taken along line IV-IV of FIG. 8. Referring to FIGS. 8 and 9, a bipolar electrode 80 according to the present exemplary embodiment includes a current collector 81, a positive active material layer 82 that is disposed along one surface of the current collector 81, a negative active material layer 83 that is disposed along the other surface of the current collector 81, and a sealing layer 85 that is formed along the surface of and at the edge of the current collector 81.

At least one hole 81a is formed in a portion in which the sealing layer 85 is formed in the current collector 81, and the sealing layer 85 is inserted into the hole 81a. When the hole 81a is formed in the current collector 81 and the sealing layer 85 is inserted into the hole 81a, the sealing layer 85 and the current collector 81 are stably coupled in a process of fusing the sealing layer 85, and when an impact is transferred from the outside, the sealing layer 85 is prevented from separating from the current collector 81.

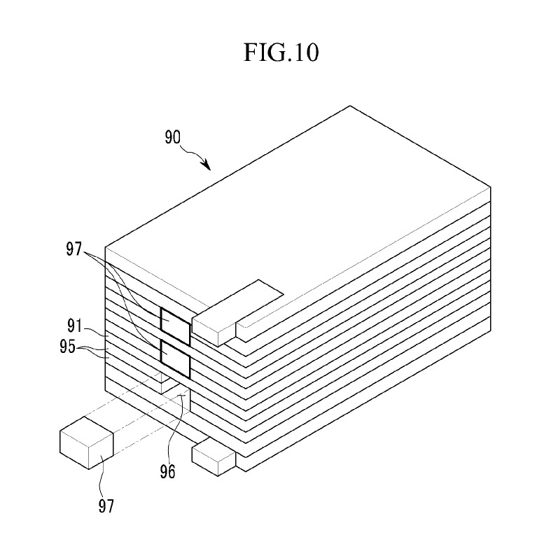

FIG. 10 is a perspective view illustrating a rechargeable battery according to still another exemplary embodiment of the present invention. A rechargeable battery 90 according to the present exemplary embodiment includes a bipolar electrode (not separately numbered) containing a current collector 91, a positive active material layer (not separately numbered) that is disposed at one surface of the current collector 91 and a negative active material layer (not separately numbered) that is disposed at the other surface of the current collector 91, and a separator (not separately numbered) that is disposed between the bipolar electrodes.

A sealing layer 95 is formed at the edge of the current collector 91, and an electrolyte injection opening 96 in which the sealing layer 95 is not formed is formed in a portion thereof. In the present exemplary embodiment, after the sealing layers 95 are bonded by pressing the stacked bipolar electrodes, an electrolyte solution is injected into the electrolyte injection opening 96, and by fusing a sealing stopper 97 or injecting adhesives to form a sealing stopper 97, the electrolyte injection opening 96 is sealed. When the electrolyte injection opening 96 is formed in the sealing layer 95, as in the present exemplary embodiment, by bonding the sealing layer 95, an internal space is formed and an electrolyte solution can be injected to thus fully fill it within the rechargeable battery 90.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A rechargeable battery comprising:
bipolar electrodes comprising a current collector, a sealing layer that is formed along one or both surfaces of and at the edge of the current collector, a first electrode active material layer that is inserted into a space where the current collector is exposed, and a second electrode active material layer that is formed along the opposite side of the current collector; and
a separator that is disposed between the bipolar electrodes, wherein the sealing layer is bonded with the sealing layers of neighboring bipolar electrodes.

2. The rechargeable battery of claim 1, wherein the sealing layer is formed along one surface of the current collector.

3. The rechargeable battery of claim 1, wherein the sealing layer is formed along both surfaces of the current collector.

4. The rechargeable battery of claim 3, wherein the second electrode active material layer is inserted into the space that is formed at the inside of the sealing layer.

5. The rechargeable battery of claim 1, wherein the sealing layer has a smaller thickness than that of the first electrode active material layer or the second electrode active material layer, and the separator is positioned within the space that is formed as the sealing layers are bonded.

6. The rechargeable battery of claim 1, wherein the separator is inserted into the space.

7. The rechargeable battery of claim 1, wherein the sealing layer protrudes to the outside of the current collector to enclose an end portion of the current collector.

8. The rechargeable battery of claim 1, wherein a space is formed in the current collector, and the sealing layer is inserted into the space.

9. The rechargeable battery of claim 1, wherein an electrolyte injection opening is formed in the bipolar electrode.

10. The rechargeable battery of claim 1, wherein the current collector and the sealing layer are formed with a laminate film.

11. The rechargeable battery of claim 10, wherein the space is formed by removing a portion of the sealing layer that is attached to the current collector.

12. The rechargeable battery of claim 1, wherein the current collector is formed with aluminum or stainless steel.

13. The rechargeable battery of claim 1, wherein the current collector is formed with a clad metal in which aluminum and copper are bonded.

14. A bipolar electrode for a rechargeable battery, comprising:
a current collector;
a sealing layer that is formed along one or both surfaces of and at the edge of the current collector;
a first electrode active material layer that is inserted into a space within the sealing layer where the current collector is exposed; and
a second electrode active material layer that is formed at the opposite surface of the current collector.

15. The bipolar electrode of claim 14, wherein the current collector and the sealing layer are formed with a laminate film.

16. The bipolar electrode of claim 14, wherein an electrolyte injection opening in which the sealing layer is not formed is formed along an edge of the current collector.

17. A method of manufacturing a rechargeable battery, the method comprising:
preparing a laminate film in which a sealing layer is bonded to both surfaces of a metal plate;
forming a space by removing a central portion of the sealing layer;
forming a bipolar electrode by disposing a positive active material layer and a negative active material layer in the space;
stacking bipolar electrodes by disposing a separator between the bipolar electrodes; and
bonding and sealing neighboring sealing layers.

18. The method of claim 17, wherein, in the stacking of bipolar electrodes, an end portion of the separator is disposed further inside than the sealing layer, and when the sealing layers are bonded, the separator is positioned within a space that is formed with the bonded sealing layer.

19. The method of claim 17, wherein, in the stacking of bipolar electrodes, the separator is inserted into the space to be disposed between the bipolar electrodes.
